(19) United States
(12) Patent Application Publication
(10) Pub. No.: US 2018/0177288 A1
(43) Pub. Date: Jun. 28, 2018

(54) HEIGHT ADJUSTABLE DESK

(71) Applicant: HI-MAX INNOVATION CO., LTD., Taichung (TW)

(72) Inventor: JHIH-FAN LIN, Taichung (TW)

(73) Assignee: HI-MAX INNOVATION CO., LTD.

(21) Appl. No.: 15/391,109

(22) Filed: Dec. 27, 2016

(51) Int. Cl. A47B 9/04; A47B 21/02; H02K 7/14; H02K 7/00; H02K 11/30; H02K 11/21

(52) U.S. Cl. CPC A47B 9/04; A47B 21/02; H02K 11/21; H02K 7/003; H02K 11/30; H02K 7/14

(57) ABSTRACT

A height adjustable desk includes a worksurface, a control module, and at least a leg module. The control module has a control circuit and a control panel electrically connected to the control circuit. The leg module has a first leg member, a second leg member and, a driving device. The first leg engages the second leg member for reciprocation. The second leg member is fixed with a block with a threaded hole. The driving device has a motor electrically connected to the control circuit and a screw rod connected to a spindle of the motor and screwed into the threaded hole of the block. When a user operates the control panel, the control circuit commands the motor to rotate the screw rod accordingly to lift or lower the work surface.

### BACKGROUND OF THE INVENTION

### 1. Technical Field

The present invention relates to a desk, and more particularly to a height adjustable desk.

### 2. Description of Related Art

According to ergonomic guideline of work place design, a height of a work surface should be influenced in part by the nature task. In the research of Ward and Kirk (1970), the tasks are classified into three type, light work, precision work and heavy work. The work-surface height for the light work should be equal to an elbow height of the worker. The work-surface height for the precision work should be higher than elbow height, and the work-surface height for the heavy work should be higher than elbow height. However, the heights of the works are different, so that the work-surface height should be adjustable according to the work's body scale to let him/her have a safe work place and an efficient performance.

A conventional height adjustable desk has a worksurface and a plurality of adjustable legs connected to a bottom of the worksurface. Each of the adjustable legs includes an upper tube connected to the worksurface and a lower tube fitted to the upper tube. The upper tube is provided with a plurality of bores, and the lower tube is provided with a bore. The upper tube is movable relative to the lower tube, and one of the bores of the upper tube is aligned with the bore of the lower tube for a pin inserted into both bores of the lower tube and the upper tube to fix them. Such desk only provides a few of heights to be adjusted that could not fit all the workers with various heights.

### BRIEF SUMMARY OF THE INVENTION

In view of the above, the primary objective of the present invention is to provide a height adjustable desk, which provides a continuous adjustment of height.

In order to achieve the objective of the present invention, a height adjustable desk includes a worksurface, a control module, and at least a leg module. The control module has a control circuit and a control panel electrically connected to the control circuit. The leg module is connected to a bottom of the worksurface, and has a first leg member, a second leg member and, a driving device. The first leg member engages the second leg member for reciprocation relative to the second leg member. The second leg member is fixed with a block with a threaded hole. The driving device has a motor fixed to the worksurface and electrically connected to the control circuit and a screw rod connected to a spindle of the motor. The screw rod is received in the first leg member, and screwed into the threaded hole of the block. When a user operates the control panel, the control circuit commands the motor to rotate the screw rod accordingly to lift or lower the worksurface.

In an embodiment, the leg module further has an inner tube fixed in the second leg member, and the block is fixed in the inner tube.

In an embodiment, the leg module further has a stand fixed to a bottom end of the second leg member, and the inner tube is fixed to a holder of the stand.

In an embodiment, the screw rod has a distal end suspend in the first leg member, and a weight member is connected to the distal end of the screw rod.

In an embodiment, each of the first and the second leg members is provided with a stopper, and the stoppers abut against each other when the worksurface is lifted to a maximum height.

In an embodiment, the driving device further has a case fixed to the bottom of the worksurface, and the motor is fixed in the case; the case is provided with an opening, and the first leg member has an end connected to the opening of the box, so that the case is communicated with the first leg member.

In an embodiment, the driving device further has a sensor connected to the spindle of the motor to sense a number of turns of the motor, and the sensor is electrically connected to the control circuit to send the control circuit a signal of the number of turns.

In an embodiment, the screw rod is provided with a space ring and a thrust bearing.

In an embodiment, the control panel is provided with a lift key and a lower key; the lift key is pressed to drives the screw rod to rotate in a direction to lift the worksurface until the user releases the lift key; the lower key is pressed to drives the screw rod to rotate in an opposite direction to lift the worksurface until the user releases the lower key.

In an embodiment, the control panel is provided with at least a memory key; the memory key is pressed to store a current height of the worksurface as a setting height in a memory of the control circuit, and the worksurface is adjusted to the setting height automatically when a user presses the memory key.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of a preferred embodiment of the present invention;

FIG. 2 is an exploded view of the leg module of the preferred embodiment of the present invention;

FIG. 3 is a sectional view of the leg module of the preferred embodiment of the present invention, showing the first leg member be lowered;

FIG. 4 is a sectional view of the leg module of the preferred embodiment of the present invention, showing the detail of the driving device;

FIG. 5 is a sectional view of the leg module of the preferred embodiment of the present invention, showing the first leg member be lifted; and

FIG. 6 is a front view of the control panel of the preferred embodiment of the present invention.

### DETAILED DESCRIPTION OF THE INVENTION

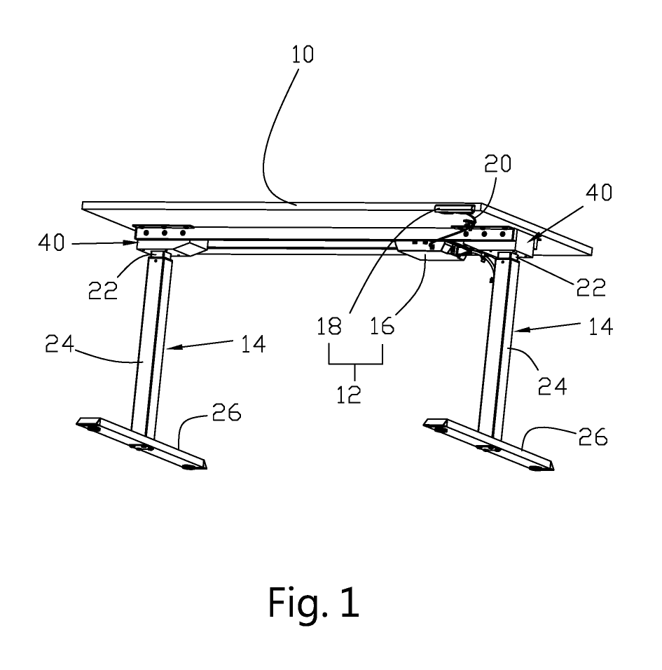

FIG. 1 shows a height adjustable desk of the preferred embodiment of the present invention includes a worksurface 10, a control module 12, and two leg modules 14.

The worksurface 10 is a rectangular board, on a bottom side of which the control module 12 and the leg modules 14 are provided.

The control module 12 includes a control box 16 and a control panel 18. The control box 16 is fixed to the bottom of the worksurface 10, in which a control circuit (not shown) and a power (not shown) are provided. The panel 18 is fixed to an edge of the worksurface 10, and electrically connected to the control circuit through a wire 20. The panel 18 has a plurality of keys for user to operate to control the leg modules 14.

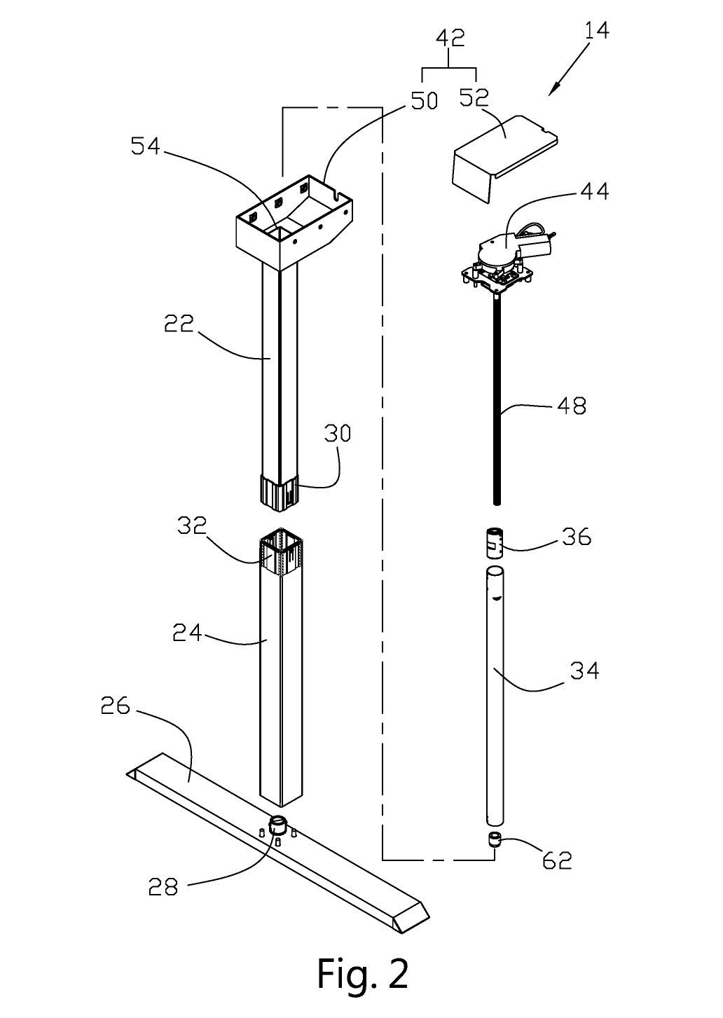

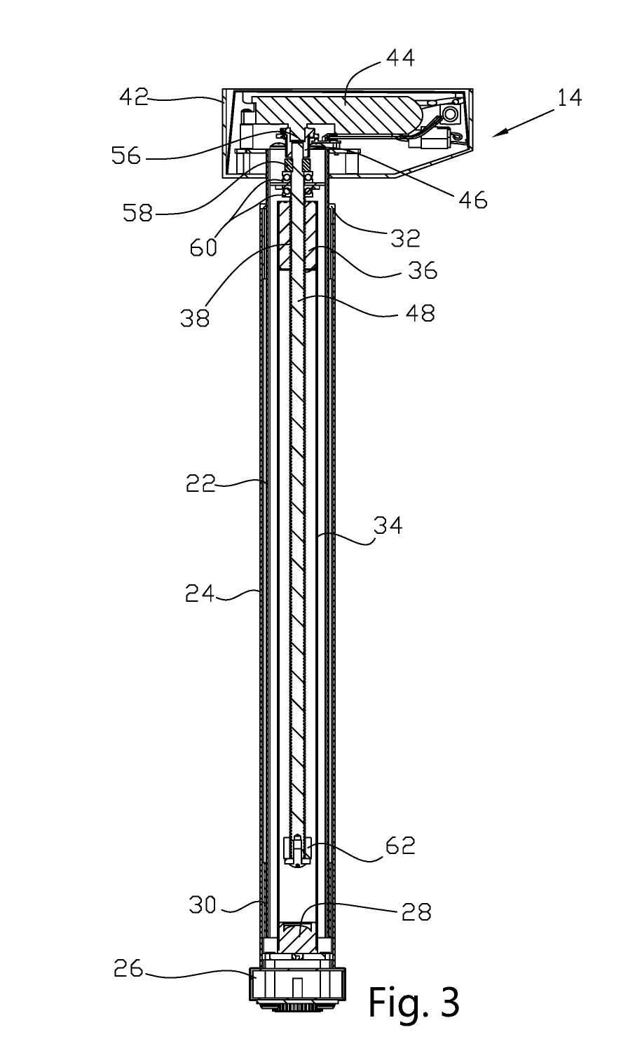

As shown in FIGS. 2 and 3, each of the leg modules 14 includes a first leg member 22, a second leg member 24, a stand 26, and a driving device 40. The first and the second leg members 22, 24 are rectangular tubular bars, and the first leg member 22 is inserted into the second leg member 24 for a reciprocation relative to the second leg member 24. The stand 26 is horizontally connected to a bottom end of the second leg member 24 to let the leg module 14 stably stand on the ground. The stand 26 is provided with a holder 28 located in the second leg member 24. The first leg member 22 is provided with a stopper 30 on an outer side and closed to a bottom end (the end inserted into the second leg member 24), and the second leg member 24 is provided with a stopper 32, which is inserted into the second leg member 24 via a top end (the end of the first leg member 22 inserted) and stopped at the top end. The stoppers 30, 32 abutted against each other while the first leg member 22 is lifted for a predetermined distance to limit the worksurface 10 with a maximum height. The second leg member 24 is received with an inner tube 34. The inner tube 34 has an end fixed to the holder 28 of the stand 26, so that the inner tube 34 is fixed to the second leg member 24 as well. A block 36 with a threaded hole 38 is fixed in the inner tube 34.

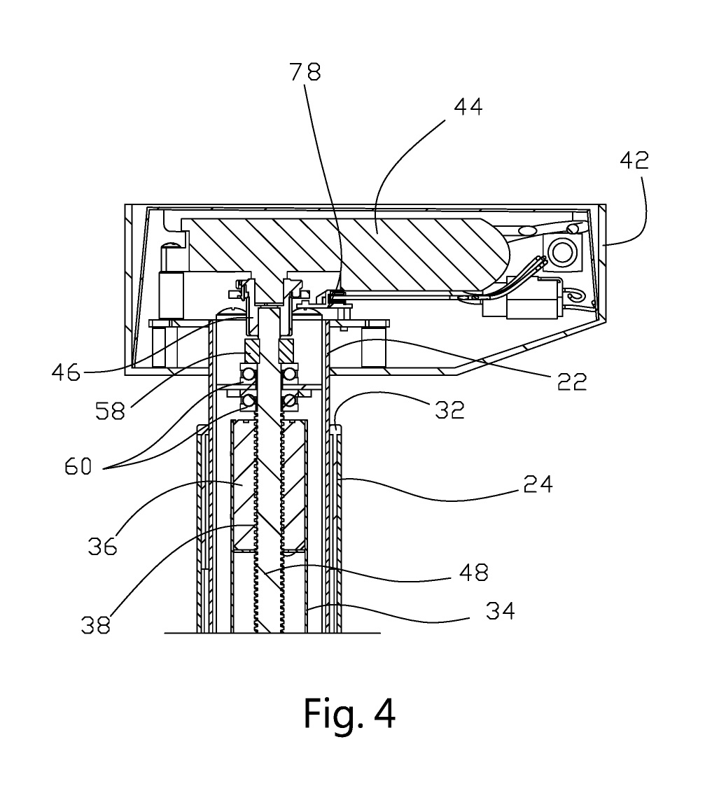

As shown in FIG. 4, the driving device 40 includes a case 42, in which a motor 44, a sensor 46, and a screw rod 48. The case 42 is fixed to the bottom of the worksurface 10. The case 42 has a box 50 and a lid 52 connected to a top of the box 50, and the box 50 has an opening 54 on a bottom thereof. The first leg member 22 has an end connected to the opening 54 of the box 50, so that the case 42 is communicated with the first leg member 22. The motor 44 is fixed in the case 42, and electrically connected to the control circuit to be driven to rotate according to a command from the control circuit. The motor 44 has a spindle 56 connected to the sensor 46 to rotate together with the spindle 56. In the present preferred embodiment, the sensor 46 is a Hall effect sensor that varies its output voltage in response to a magnetic field to detect a number of turns of the spindle 56. The sensor 46 is electrically connected to the control circuit, and sends it a signal of the number of turns. In another embodiment, the sensor 46 could be any suitable sensor for sensing the rotation of the motor 44, such as optical gate sensor and infrared rays sensor. The screw rod 48 has an end connected to the sensor 46, so that the screw rod 48 is driven by the motor 44. A space ring 58 and two thrust bearings 60 are provided onto the screw rod 48. The thrust bearings 60 are between the first leg member 22 and the screw rod 48. The screw rod 48 is screwed into the threaded hole 38 of the block 36, and received in the inner tube 34. A weight member 62 is fixed to a distal end of the screw rod 48. Since the screw rod 48 is suspended in the inner tube 34, the weight member 62 is helpful to a stable rotation of the screw rod 48.

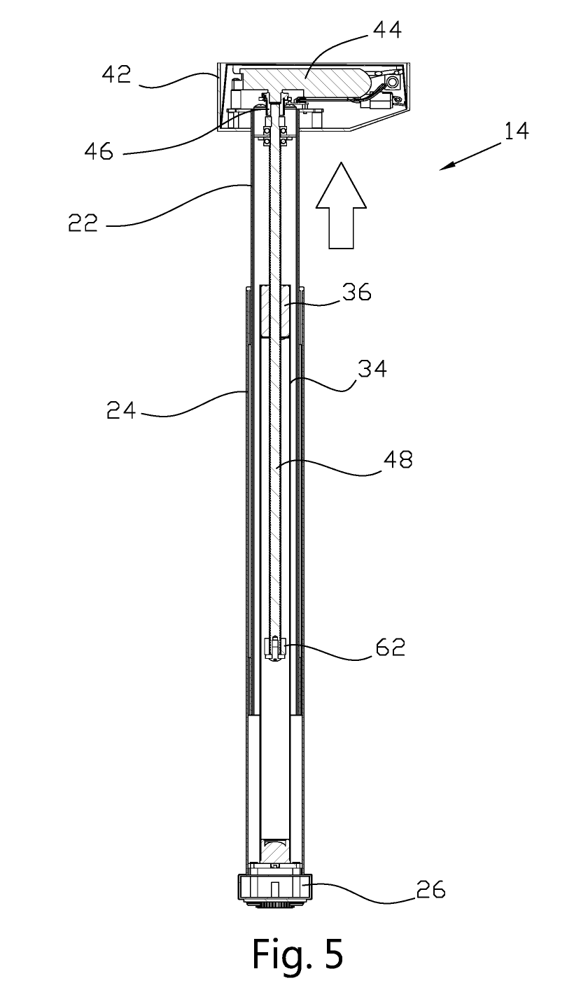

When a user operates the control panel 18, and control circuit drives the motor 44 to rotate accordingly, and the screw rod 48 is rotated at the same time. Since the block 36 is fixed to the second leg member 24 through the inner tube 34 and the stand 26, the first leg member 22 will be reciprocated relative to the second leg member 24 when the motor 44 is started. As a result, the worksurface 10 lifted (FIG. 5) or lowered (FIG. 3) according to the operation of the user.

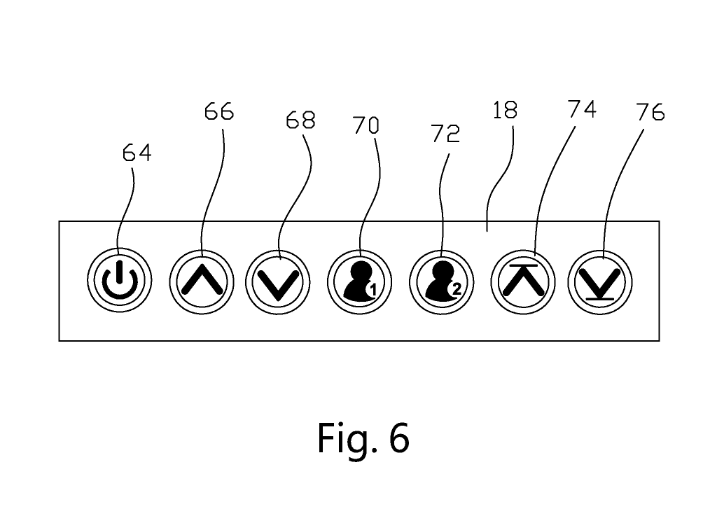

In the present preferred embodiment, as shown in FIG. 6, the control panel 18 is provided with a power key 64, a lift key 66, a lower key 68, two memory keys 70, 72, a highest key 74, and a lowest key 76. When a user presses the lift key 66, the motor 44 drives the screw rod 48 to rotate in a direction to lift the worksurface 10 until the user releases the lift key 66. Similarly, the user pressing the lower key 68 will drive screw rod 48 to rotate in an opposite direction to lower the worksurface 10 until the user releases the lower key 68. When a user adjusts the worksurface 10 to a desired height, he/she can press the first memory key 70 for a predetermined time (three seconds for example), and the control circuit will store the current height in a memory thereof as a first setting height. Therefore, the worksurface 10 will be adjusted to the first setting height when the user presses the first memory key 70. The control panel 18 provides two memory keys 70, 72 which means that two setting heights could be stored. The worksurface 10 will be lifted to a highest position when the user presses the highest key 74, and lowered to a lowest position when the user presses the lowest key 76. It is noted that the sensor 46 serves the key function of the adjustment of the worksurface 10 to the setting heights. The number of turns of the motor 44 sensed by the sensor 46 is sent to the control circuit and memorized to acknowledge a current height of the worksurface 10. The current height is compared with the setting height to control the motor 44 accordingly. In another preferred embodiment, the control panel 18 is provided with a plurality of height keys (not shown) instead of the memory keys. The manufacturer pre-sets some set heights of the worksurface 10 to the height keys, so that the worksurface 10 could be adjusted to the set heights when the user presses the height keys.

It must be pointed out that the embodiments described above are only some preferred embodiments of the present invention. All equivalent structures which employ the concepts disclosed in this specification and the appended claims should fall within the scope of the present invention.

1. A height adjustable desk, comprising:
a worksurface;
a control module having a control circuit and a control panel electrically connected to the control circuit; and
at least a leg module connected to a bottom of the worksurface, and having a first leg member, a second leg member and, a driving device; the first leg member engaging the second leg member for reciprocation relative to the second leg member; the second leg member fixed with a block with a threaded hole; the driving device having a motor fixed to the worksurface and electrically connected to the control circuit and a screw rod connected to a spindle of the motor, received in the first leg member, and screwed into the threaded hole of the block;
whereby when a user operates the control panel, the control circuit is configured to commands the motor to rotate the screw rod accordingly to lift or lower the worksurface;
wherein the driving device further has a sensor connected to the spindle of the motor to sense a number of turns of the motor, and the sensor is electrically connected to the control circuit to send the control circuit a signal of the number of turns;
wherein a sensor has opposite end connected to the spindle of the motor and the screw rod to be simultaneously turned with the spindle of the motor and the screw rod.

2. The height adjustable desk of claim 1, wherein the leg module further has an inner tube fixed in the second leg member, and the block is fixed in the inner tube.

3. The height adjustable desk of claim 2, wherein the leg module further has a stand fixed to a bottom end of the second leg member, and the inner tube is fixed to a holder of the stand.

4. The height adjustable desk of claim 1, wherein the screw rod has a distal end suspend in the first leg member, and a weight member is connected to the distal end of the screw rod.

5. The height adjustable desk of claim 1, wherein each of the first and the second leg members comprises a stopper, respectively, and the stoppers are configured to abut against each other when the worksurface is lifted to a maximum height.

6. The height adjustable desk of claim 1, wherein the driving device further has a case fixed to the bottom of the worksurface, and the motor is fixed in the case; the case comprises an opening, and the first leg member has an end connected to the opening of the box, so that the case is communicated with the first leg member.

7. (canceled)

8. The height adjustable desk of claim 1, wherein the screw rod comprises a space ring and a thrust bearing.

9. The height adjustable desk of claim 1, wherein the control panel comprises a lift key and a lower key; the lift key is configured to be pressed to drives the screw rod to rotate in a direction to lift the worksurface until the lift key is configured to be pressed by a user; the lower key is configured to be pressed to drives the screw rod to rotate in an opposite direction to lift the worksurface until the lower key is configured to be pressed by a user.

10. The height adjustable desk of claim 1, wherein the control panel comprises at least a memory key; the memory key is configured to be pressed to store a current height of the worksurface as a setting height in a memory of the control circuit, and the worksurface is configured to be adjusted to the setting height automatically when the memory key is configured to be pressed by a user.

11. The height adjustable desk of claim 1, wherein the control panel comprises a highest key configured to be pressed by a user for lifting the worksurface to a highest position, and a lowest key configured to be pressed by a user for lowering the worksurface to a lowest position.
